(19) United States
(12) Patent Application Publication
(10) Pub. No.: US 2011/0115303 A1
(43) Pub. Date: May 19, 2011

(54) MULTIPLE USE WIRELESS POWER SYSTEMS

(75) Inventors: David W. Baarman, Fennville, MI (US); Joshua B. Taylor, Rockford, MI (US); Joshua K. Schwannecke, Grand Rapids, MI (US); Scott A. Mollema, Rockford, MI (US)

(73) Assignee: ACCESS BUSINESS GROUP INTERNATIONAL LLC, Ada, MI (US)

(21) Appl. No.: 12/949,317

(22) Filed: Nov. 18, 2010

Related U.S. Application Data
(60) Provisional application No. 61/262,689, filed on Nov. 19, 2009.

(51) Int. Cl. H01F 38/14; H02J 17/00

(52) U.S. Cl. 307/104

(57) ABSTRACT

A wireless power system having at least one of a remote device with multiple wireless power inputs capable of receiving power from a different wireless power source, a remote device including a hybrid secondary that can be selectively configured for multiple uses, a remote device including a hybrid secondary, a far field wireless power source having a low power mode, a remote device having the capability of communicating with multiple different wireless power sources to indicate that a wireless power hot spot is nearby, a wireless power supply including multiple wireless power transmitters.

### BACKGROUND

The widespread and continually growing use of portable electronic devices has led to a dramatic increase in the need for wireless power solutions. Wireless power supply systems eliminate the need for power cords and therefore eliminate the many inconveniences associated with power cords. For example, wireless power solutions can eliminate: (i) the need to retain and store a collection of power cords, (ii) the unsightly mess created by cords, (iii) the need to repeatedly physically connect and physically disconnect remote devices with cords, (iv) the need to carry power cords whenever power is required, such as recharging, and (v) the difficulty of identifying which of a collection of power cords is used for each device.

There are a number of different types of wireless power supply systems. For example, many wireless power supply systems rely on inductive power transfer to convey electrical power without wires. One wireless power transfer system includes an inductive power supply that uses a primary coil to wirelessly convey energy in the form of a varying electromagnetic field and a remote device that uses a secondary coil to convert the energy in the electromagnetic field into electrical power. Other types of known wireless power transfer solutions include RF resonant wireless power systems, RF multiple filter broadcast wireless power systems and magnetic resonance or resonant inductive coupling, wireless power systems to name a few. A number of existing wireless power systems utilize communications between the power transfer system and the remote device to assist in the transfer of power.

Efforts to provide a universal wireless power solution are complicated by a variety of practical difficulties. One difficulty is the lack of wireless power source infrastructure. For now, the number of available wireless power sources is relatively small compared to the number of remote devices. This issue is exacerbated by the incompatibility between some remote devices and some wireless power supply systems. In order for a remote device to receive wireless power from a wireless power supply, the remote device typically includes a wireless power receiver. Wireless power receivers often include different components or are controlled differently depending on the intended wireless power source. For example, a remote device may include an RF antenna if it receives power by RF harvesting, a different remote device may include a secondary coil with a particular set of parameters to receive power by resonant inductive coupling or magnetic resonance, and yet another remote device may include an LC circuit and a secondary coil to receive mid range inductive resonant power. Another example is a mid range system tuned to a larger coil that may prohibit good coupling at very close ranges and then switches to resonant inductive coupling at closer distances while tuning the LC circuit. Currently, remote devices capable of receiving wireless power include a single wireless power receiving system and therefore are only capable of utilizing a subset of the wireless power infrastructure. Unfortunately, it is likely impractical, for a variety of reasons, to include separate wireless power receiving systems for each type of desired wireless power. One reason being that the available space in consumer electronics is shrinking. Another reason is that including circuitry for each wireless power receiver such as a separate receiving element, separate communication system, separate rectifier, and separate controller adds to the cost and size of the remote device. If multiple separate wireless power systems are used, the system would include several controllers, communication systems, and rectifiers increasing cost and size.

In addition to the complexities with a universal wireless power solution, there are also issues that arise due to the interactions between the remote device wireless power systems and remote device communication systems. For example, certain wireless power sources can interfere or harm remote device communication systems in some circumstances. Each system may be used in space or time to provide the best power over multiple use scenarios. Further, the space concerns mentioned above with respect to multiple wireless power supplies also extend to having a wireless receiver system and a separate communication system that take up valuable space within the remote device.

As wireless power technologies evolve and become more common, supporting infrastructure and the ability to communicate with that infrastructure will become increasingly important. It is likely that consumers will want to be able to charge their devices at as many wireless hot spots as possible, not just a subset of hot spots that support the technology in their particular device.

### SUMMARY OF THE INVENTION

In a first aspect of the invention, a remote device is adapted to manage multiple wireless power inputs, where each wireless power input is capable of receiving power from a different wireless power source. The remote device includes a controller capable of monitoring multiple wireless power inputs and if appropriate, capable of communicating with one or more wireless power sources using multiple communications methods. In one embodiment, at least some of the wireless power inputs share at least one element of a rectifier, a controller, and a communication system. In one embodiment, a controller is programmed to manage the multiple wireless power inputs by deciding which, if any, of the wireless power inputs should be used to provide power to the load of the remote device. The controller may consider a variety of factors in making the decision, such as one or more of the characteristics of power present on each wireless power input. It may also consider the power state and load to provide power and charging options and convey information to the user. A controller may be programmed to determine which power input will have the best efficiency or highest charge capability and decide to use several wireless power inputs or use a selected source. Further, the controller may cooperate with a power management system of the remote device in the management decisions.

In a second aspect of the invention, a remote device includes a hybrid secondary that can be selectively configured for multiple uses. In one embodiment, the hybrid secondary may be selectively configured to either wirelessly receive power or to wirelessly communicate high speed data. In another embodiment, the hybrid secondary element may be selectively configured to either receive wireless power from a first wireless power supply or to receive wireless power from a second wireless power supply. The hybrid secondary occupies less space than two corresponding separate secondary elements. A hybrid secondary may be utilized within one area of the device to minimize size and incorporate several wireless power elements for best use of a space exposed to the outside world know as an aperture for wireless power. For example, where the remote device includes a housing having an aperture capable of passing wireless communication and wireless power, the hybrid secondary element may occupy a relatively smaller amount of physical space within the aperture of the remote device than two separate secondary elements would occupy in the aperture.

In this aspect of the invention multiple wireless receivers may be combined in one area to maximize packaging and minimize the amount of device real-estate used by the wireless power system. Using a single aperture in the device with multiple coils and antennas to minimize the packaging spaced used. This is easiest to tune and understand if it is designed into a single module. It may be placed on a very high impedance substrate, a ferrite place or stamped in metal powder to encapsulate all sides but the coil facing side of the system to complete the aperture.

In a third aspect of the invention, a remote device includes a power receiving element and a communication element. A controller in the remote device is capable of selectively coupling the power receiving element to the load and the communication element to communication circuitry. During power transfer, the controller disconnects the communication element so that the wireless power does not interfere with the communication element or associated circuitry. In one embodiment, the power receiving element or a portion of the power receiving element may be utilized as the communication element when the power receiving element is not in use. In one embodiment, a control circuit in the remote device automatically switches to a higher speed communication mode while no power transfer is taking place where the communication element is used for communication. This mode can selectively switch to a particular communications element for high speed communications depending on the communication interface. While power transfer is taking place, a lower speed communication mode may be utilized, for example by using backscatter modulation on the power receiving element.

In a fourth aspect of the invention, a remote device has the capability of communicating with a far field wireless power source having a low power mode. The communication between the remote device and the far field wireless power source may be utilized to control the far field wireless power source. In one embodiment, a far field wireless power source has a low power mode where the far field wireless power source transmits a low power intermittent wireless signal. A remote device may receive the signal and communicate back a wireless signal to move the device out of low power mode and enable the transmission of far field wireless power. In another embodiment, a remote device may transmit an wireless signal, periodically or in response to user input. If a far field wireless power source is within range, it may leave the low power mode and begin broadcasting wireless far field power for the remote device to receive. The far field wireless power source utilizes less power during low power mode than during power transmission mode. For example, during the lower power mode the far field wireless source may power down various circuitry or disconnect the power input and rely on an electrical storage element for power.

In a fifth aspect of the invention, a remote device has the capability of communicating with multiple different wireless power sources to indicate that a wireless power hot spot is nearby. The remote device transmits a wireless signal and if a wireless power source is present, but not within range for the remote device to receive wireless power then the wireless power source may respond by transmitting a wireless signal indicating that a wireless hotspot is nearby. The indication signal may include a variety of different information, such as power class information, location information, cost information, capacity information, and availability information.

In a sixth aspect of the invention a wireless power supply includes multiple wireless power transmitters. The system can use the combined effects of various wireless power systems based on range, power and feedback from the remote device. Together with the remote device the system can decide which wireless power system provides the optimal power transfer.

These and other features of the invention will be more fully understood and appreciated by reference to the description of the embodiments and the drawings.

### BRIEF DESCRIPTION OF THE DRAWINGS

FIG. 1 shows a block diagram of a wireless power system including a remote device with multiple wireless receivers.

FIG. 2 shows a schematic of a remote device multiple wireless power input system.

FIG. 3 shows a block diagram of a wireless power system including a remote device with a power receiving element and a communication element.

FIG. 4 shows a block diagram of a remote device including a communication system for communicating at a lower rate during power transfer and a separate communication system for communicating at a higher rate while power is not being transferred.

FIG. 5 shows a representative graph of wireless power transfer and communication.

FIG. 6 shows a flowchart for enabling high-speed communication while wireless power transfer is not taking place.

FIG. 7 shows a block diagram of wireless power supply to device communication and device to device communications.

FIG. 8 shows a flowchart for enabling device to device communication.

FIG. 9 shows how an RF communication system can enable a low power mode for a far field power supply.

FIG. 10 shows a wireless signal sequence that can be initiated from the transmitter or the receiver to enable far field power transfer power.

FIG. 11 shows an isolated energy storage circuit used to store energy and send a signal to identify a wireless power hot spot.

FIG. 12 shows a wireless receiver module ready for tuning and assembly manufactured in a way that allows the coils to be predictable.

FIG. 13 shows a wireless power supply that includes multiple wireless power transmitters.

### DESCRIPTION OF EMBODIMENTS

### I. Overview

A number of different aspects of a wireless power transfer system including a remote device capable of receiving wireless power are described below. There are a number of different features discussed including, but not limited to, a remote device with multiple wireless power inputs, a remote device with a hybrid secondary, a remote device with the ability to time slice communications, a remote device with the ability to wirelessly communicate with a far field wireless power source to enable a low power mode, and a remote device capable of determining whether a wireless hot spot is nearby.

### II. Multiple Wireless Power Inputs

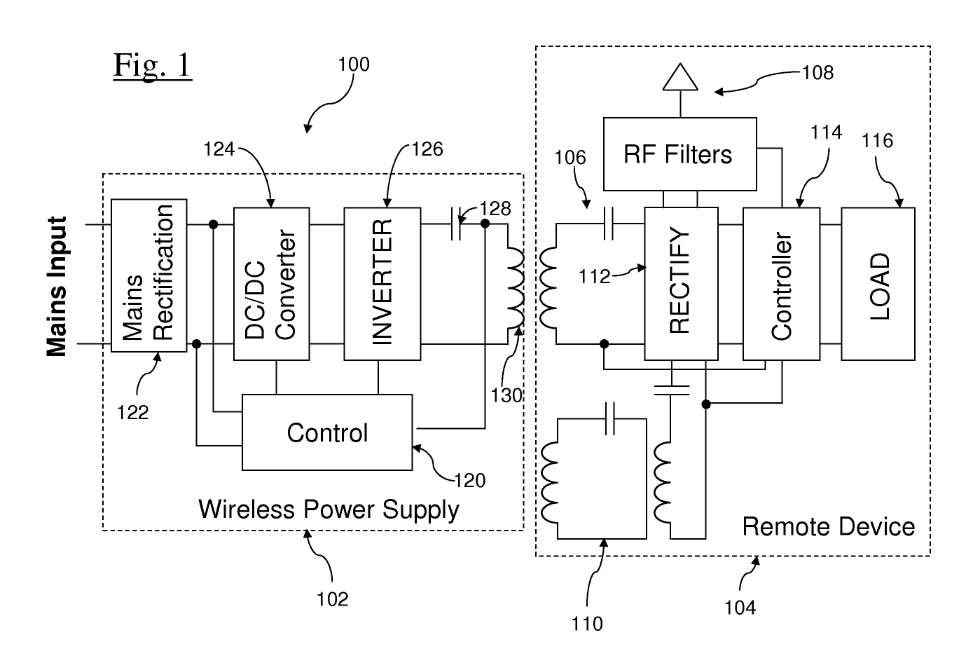

A wireless power supply system in accordance with an embodiment of one aspect of the present invention is shown in FIG. 1, and generally designated 100. The wireless power supply system 100 includes one or more wireless power supplies 102 and one or more remote devices 104. In this aspect of the invention, the remote device 104 is adapted to manage multiple wireless power inputs, where each power input is capable of receiving power from a different wireless power source. In some embodiments, where the design converges toward simplicity coils 106 and 110 may be combined. The combined hybrid secondary may have LC tuning or the operating frequency may be normalized for multiple input types.

A. Wireless Power Sources

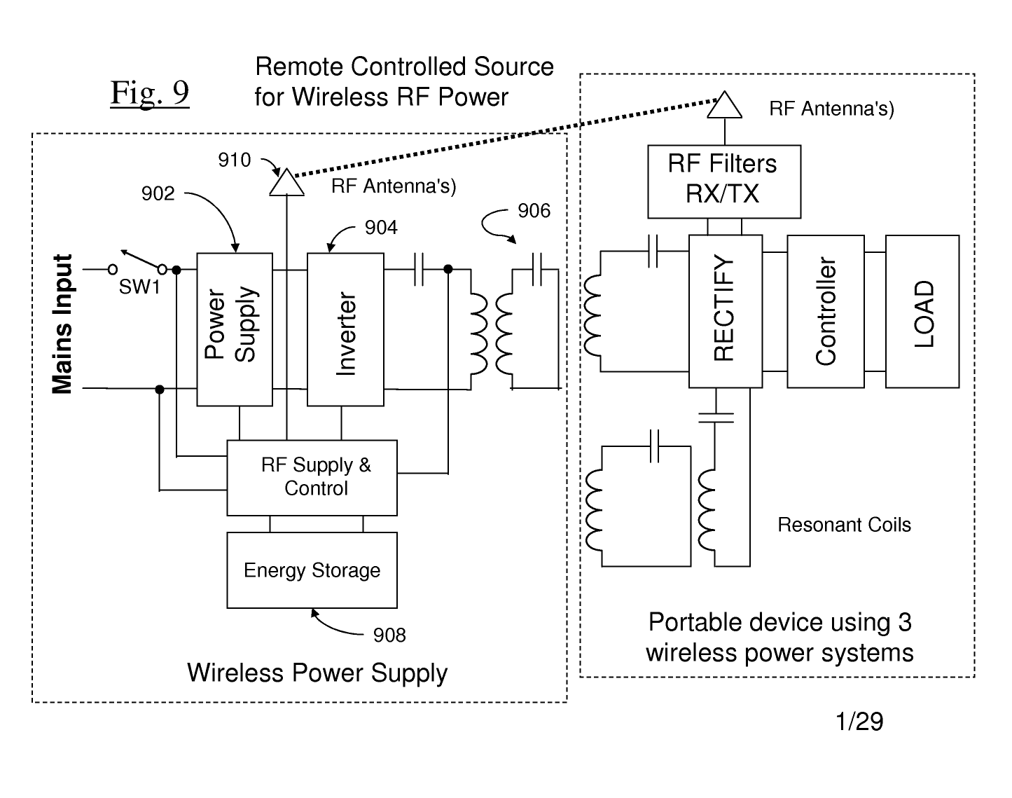

The present invention is suitable for use with a wide variety of wireless power sources. As used herein, the term “wireless power source” is intended to broadly include any wireless power supply capable of providing power wirelessly as well as any wireless power source of ambient energy capable of being harvested and turned into electrical energy. Wireless power sources may provide wireless power through the electromagnetic near field power, the electromagnetic far field, magnetic resonance, or any other suitable wireless power source. For example, the wireless power supply may be a resonant inductive power supply such as the wireless power supply 102 shown in FIG. 1. Another example is the RF resonant wireless power supply shown in FIG. 9. Other examples of wireless power sources include an RF broadcast system (not shown) or an ambient source of RF energy (not shown). Other examples of suitable wireless power supplies are described in the following patents or patent publications, which are each hereby incorporated by reference:
U.S. Pat. No. 6,825,620 to Kuennen et al, entitled “Inductively Coupled Ballast Circuit” issued Nov. 30, 2004 (U.S. Ser. No. 10/246,155, filed on Sep. 18, 2002)
U.S. Pat. No. 7,212,414 to Baarman, entitled “Adapted Inductive Power Supply” issued on May 1, 2007 (U.S. Ser. No. 10/689,499, filed on Oct. 20, 2003)
U.S. Pat. No. 7,522,878 to Baarman, entitled “Adaptive Inductive Power Supply with Communication” issued on Apr. 21, 2009 (U.S. Ser. No. 10/689,148, filed on Oct. 20, 2003)
U.S. Patent Publication 2009/0174263 to Baarman et al, entitled “Inductive Power Supply with Duty Cycle Control” published on Jul. 9, 2009 (U.S. Ser. No. 12/349,840, filed on Jan. 7, 2009)
U.S. Pat. No. 7,027,311 to Vanderelli et al, entitled “Method and Apparatus for a Wireless Power Supply” issued Apr. 11, 2006 (U.S. Ser. No. 10/966,880, filed Oct. 15, 2004)
U.S. Pat. Publication 2008/0211320 to Cook (U.S. Ser. No. 12/018,069, filed Jan. 22, 2008)

In the illustrated embodiment, the wireless power supply 102 includes a primary controller 120, mains rectification circuitry 122, a DC/DC converter 124, an inverter 126, and a tank circuit including a primary 130 and a capacitor 128. In operation, the mains rectification 122, primary controller 120, DC/DC converter 124, and inverter 126 apply power to the tank circuit 320 to generate a source of electromagnetic inductive power.

In the illustrated embodiment, the wireless power supply 102 is configured to wirelessly supply power using generally conventional inductive power transfer techniques and apparatus. The specifics regarding most resonant and non resonant inductive wireless power transfer techniques are known, and thus will not be discussed in great detail. In general, the primary 130 may produce an electromagnetic field that may be picked up and used to generate power in a wireless electronic device, sometimes referred to as a remote device. The primary 130 of this embodiment is a primary coil of wire configured to produce an electromagnetic field suitable for inductively transmitting power to a remote device 104.

The wireless power supply 102 includes an AC/DC rectifier 122 for converting the AC power received from the AC mains into DC power. The power supply 102 also includes a DC/DC converter 124 for converting the DC output of the AC/DC rectifier 122 to the desired level. The power supply 102 also includes a microcontroller 120 and an inverter 126 (sometimes referred to as a switching circuit). The microcontroller 120 is programmed to control the inverter 126 to generate the appropriate AC power for the primary 130. In this embodiment, the microcontroller 120 can control operation of the DC/DC converter 124 or the inverter 126. The microcontroller 120 may determine the appropriate DC power level or the appropriate operating frequency based on signals received from the wireless device. These signals may be communicated from the wireless device to the power supply 102 by reflected impedance or through a separate communications system, such as a separate inductive coupling utilizing for example, near field communication protocol, infrared communications, WiFi communications, Bluetooth communications or other communication schemes. The microcontroller 120 may follow essentially any of a wide variety of inductive power supply control algorithms. In some embodiments, the microcontroller 120 may vary one or more characteristics of the power applied to the primary 130 based on feedback from the remote device 104. For example, the microcontroller 102 may adjust the resonant frequency of the tank circuit (e.g. the coil and capacitor combination), the operating frequency of the inverter 126, the rail voltage applied to the primary or switching circuit to control amplitude 130 or the duty cycle of the power applied to primary 130 to affect the efficiency or amount of power inductively transferred to the remote device 104. A wide variety of techniques and apparatus are known for controlling operation of an inductive power supply. For example, the microcontroller may be programmed to operate in accordance with one of the control algorithms disclosed in the references incorporated by reference above.

Another type of wireless power supply is a near field far edge wireless power supply. The specifics regarding near field far edge wireless power supplies are known, and thus will not be discussed in detail. This system uses a larger primary inductive loop with a higher Q to induce a higher magnetic profile for additional distance while reducing the required energy within the resonant system.

Yet another type of wireless power supply solution is energy harvesting. Energy harvesting involves converting ambient energy into electrical energy. For example, electromagnetic energy harvesting, Electrostatic energy harvesting, pyroelectric energy harvesting, and piezoelectric energy harvesting are a few known energy harvesting techniques. The specifics regarding energy harvesting are known and thus will not be discussed in detail. Suffice it to say, most energy harvesting does not include a wireless power source designed to transmit energy for harvesting. Instead, most energy harvesting solutions leverage ambient energy that exists for some other purpose than for supplying wireless power. That being said, it is possible to broadcast RF energy for the purpose of harvesting the energy.

B. Remote Device

In the current embodiment, the remote device 104 includes a plurality of wireless power receivers 106, 108, 110. The remote device 104 also includes rectification circuitry 112, a controller 114, and a load 116.

In the current embodiment, the plurality of wireless power receivers 106, 108, 110 include a wireless power receiver for receiving inductive power 106, a wireless power receiver for receiving RF resonant power 108, and a wireless power receiver for harvesting RF energy 110. In alternative embodiments, the remote device may include additional or fewer wireless power receivers. For example, in one embodiment, the remote device may include one wireless power receiver for receiving inductive power and one wireless power receiver for receiving RF resonant power. In another embodiment, the remote device may include two wireless power receivers for receiving inductive wireless power from different types of inductive power sources.

The specifics regarding the particular wireless power receivers are known and therefore will not be discussed in detail. The inductive power receiver 106 includes a secondary coil and a resonant capacitor. Several different types of inductive power receivers are described in the disclosures incorporated by reference above. The resonant induction power receiver 110 may include an isolated LC circuit and a secondary coil for coupling to the LC circuit. This system is designed to have a higher Q and extend the magnetic field to provide a medium range power source. The harvesting receiver 108 includes an RF antenna and RF filter circuitry. One RF harvesting receiver is described in U.S. Pat. No. 7,027,311 to Vanderelli et al entitled “Method and Apparatus for a Wireless Power Supply” (U.S. Ser. No. 10/966,880, filed Oct. 14, 2004), which is hereby incorporated by reference.

The remote device of the current embodiment includes an AC/DC rectifier 112 for converting the AC wireless power received into DC power. In one embodiment, all of the wireless power receivers are connected to the input of a single AC/DC rectifier. In some embodiments, the AC/DC rectifier selectively connects to one of the wireless power receivers based on input from the controller 114. In other embodiments, some or all of the wireless power receivers have their own rectification circuitry. Synchronous rectification circuitry may be used to reduce losses. Further, multiple wireless power inputs may utilize the same rectification circuitry or portions of the same circuitry.

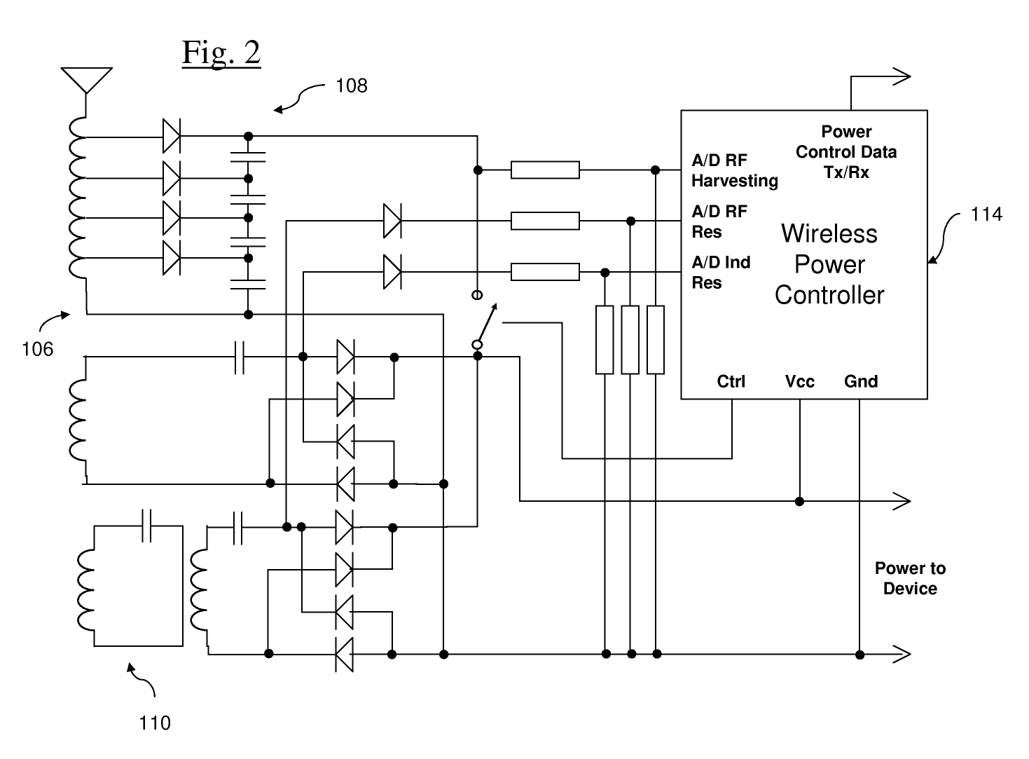

The use of separate rectification circuitry for each wireless power receiver is illustrated in FIG. 2. The circuit disclosed in FIG. 2 includes efficient rectification circuitry that is tailored specifically to each wireless power receiver and helps to prevent losses during the conversion from AC power to DC power. Other rectification circuitry, such as synchronous rectification circuitry could also be used. Further, in some embodiments, multiple channel rectification allowing several power inputs to be summed, including synchronous methods could be used simultaneously while using one of the available power inputs to enable the wireless power controller in order to allow the wireless power controller to manage the multiple wireless power inputs. The controller may identify which system is contributing power for proper control and user interface.

The wireless power controller 114 can monitor multiple wireless power inputs and control multiple wireless sources via communication, if appropriate. The system can monitor inputs from each source and determine which has the best performance or other desired characteristics using communications and measurements such as voltage and current for each input source. The controller determines which system performs the best in specific predefined conditions and ranges. For example, the wireless power controller may communicate with a wireless power source within range to adjust power level or a number of other parameters. There are a variety of communication paths available for the wireless power controller 114 to communicate with a wireless power source. The communication path may include reflected impedance over one of the wireless power receivers or be through a separate communications system, such as a separate inductive coupling utilizing for example, near field communication protocol or, infrared communications, WiFi communications, Bluetooth communications or other communication schemes. In one embodiment, the wireless power controller 114 utilizes the same wireless power receiver over which power was transferred in order to communicate back to that wireless power source. In an alternative embodiment, the wireless power controller 114 utilizes a predetermined wireless power receiver for all communication to wireless power sources. In yet another alternative embodiment, the wireless power controller 114 utilizes a separate transmitter to communicate with any wireless power source. The communication path may be the same for all wireless power receivers or it may be differ for each wireless power receiver. Sharing a communication path allows the multiple wireless receivers to use most of the same wireless power control system and leverage some of the same components. Further, in embodiments with an RF wireless power receiver, the RF wireless power receiver may be utilized for both the communication path and to provide RF harvesting.

The wireless power controller may communicate with a device power management system (not shown) on the remote device in order to cooperate regarding various power management decisions, such as which remote device systems should be powered or which wireless power input should be utilized.

In systems without a power management system, the wireless power controller may be programmed with any suitable priority scheme. For example, a preset priority to resolve conflicts when power is available on multiple wireless power inputs may be utilized. In other embodiments, the priority could be a ranking of the wireless power receivers based on any number of factors like performance, efficiency and range. In one embodiment, the priority scheme is based on a set of criteria, where the wireless power input with the most available power is selected to provide power to the wireless controller and other remote device circuitry until the various decisions regarding the wireless power inputs can be determined.

In systems with a power management system, the wireless power controller may be programmed to cooperate with the power management system in order to make various decisions with regard to the wireless power. For example, the wireless power controller and the power management system may decide which remote device systems should be powered to minimize the amount of power being used and maximize the charge and device battery life. This may be to reduce losses by managing the amplitude of power between devices. An example would be powering a laptop and a headset. Another example would be based on selecting the best performance for a given range.

For example, where RF harvesting is the only available wireless power input, the system may “fold” back system power in response to the lower wireless input level in an attempt to have an overall positive impact to the battery. In order to perform this functionality, the remote device may have available the device power usage (obtainable from the power management system) and the available wireless input power (obtainable from the wireless power controller). Using this information, the remote device can make an informed decision to lower the device power to be lower than the available wireless input power. Additional options are also available, for example, the remote device could decide to shut down the device in order to provide a better charge to the remote device load, which typically includes a battery. This option could be presented as a consumer option or automatic based on battery level. The threshold battery level could be permanently set at manufacture or set and left as a configurable variable for the user. This may prevent a completely discharged battery by maintaining a charge when the battery would attempt to completely discharge.

Multiple wireless power inputs may provide power simultaneously or at different points in time. Where there is a single wireless power input present at a particular point in time, the remote device may utilizes that wireless power input to power the load of the remote device. Where there are multiple wireless power inputs available, the controller determines the appropriate wireless power input to utilize or manages each system respectively. In one embodiment, the remote device may instruct the wireless power source or sources associated with the unused wireless power inputs to send less power to save the amount of power being wirelessly transmitted and wasted. The system will have an understanding of the efficiency of each system which is shared using communications. The receiver can then make a decision to use the system that is highest in efficiency given that configuration. In alternative embodiments, where multiple wireless power inputs are available, the remote device may utilize multiple sources by combining the input power or powering different portions of the remote device load.

Some wireless power supplies may be incapable of transmitting power simultaneously within the same vicinity. The RF and larger coil mid range power could be summed and potentially even the smaller inductive coil if the systems do not interfere. In these situations, the remote device may have a method for deciding which of a plurality of different wireless power supplies should provide power. For example, if a large coil resonant wireless power supply and a small coil resonant inductive power supply are both within range to supply power to the remote device, the remote device may be programmed to determine which of the two power supplies is more appropriate to provide power. The determination may be based on a wide variety of factors, such as the desired power level, a comparison of the relative estimated efficiency of each power source, battery level, or a number of other factors.

### III. Hybrid Wireless Power Input

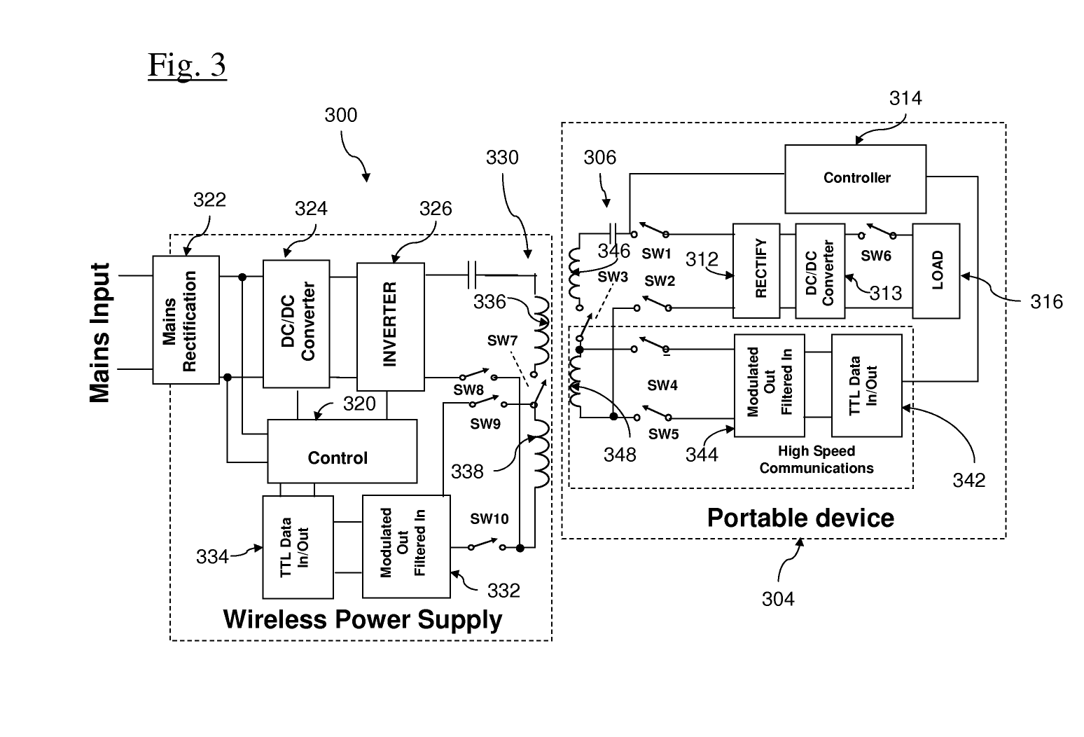

A wireless power supply system in accordance with an embodiment of one aspect of the present invention is shown in FIG. 3, and generally designated 300. The wireless power supply system 300 includes one or more wireless power supplies 302 and one or more remote devices 304. In this aspect of the invention, the remote device 304 includes a hybrid secondary 306 that may be selectively configured to either wirelessly receive power or to wirelessly communicate high speed data. Data transfer may use a single loop of wire while power transfer may use additional turns. The switches select the configuration and allow the proper functionality.

The wireless power supply 302 is similar to the wireless power supply 102 described above, except that it includes high-speed communication capability. The wireless power supply 102 includes a mains rectification 322, a DC/DC converter 324, an inverter 326, and a controller 320 that all act in a similar manner to the corresponding components in the wireless power supply 102. In the current embodiment, the structural differences from the wireless power supply 102 include the hybrid primary 330, conditioning circuitry 332, and some transistor-transistor logic 334. The controller 320 also includes some additional programming associated with the high-speed communications capability. In alternative embodiments, the wireless power supply does not include a hybrid primary, but instead includes a conventional primary and a separate high-speed communication coil.

In the current embodiment, the hybrid primary 330 includes a portion of a primary coil 336 and a communication coil 338 selectably connected by way of a switch SW7. The hybrid primary 330 may be configured in a first configuration for transmitting wireless power by closing switches SW8 and SW7 and opening switches SW9 and SW10. This creates an open circuit to the communication circuitry 332, 334 and allows the wireless power supply 302 to transmit power in a similar fashion to wireless power supply 102 described above. During this configuration, the communication coil 338 is electrically connected in series with the portion of the primary coil 336 and together they act similarly to the primary coil 130 described in connection with wireless power supply 102. The hybrid primary 330 may be configured in a second configuration for communicating high speed data by opening switches SW7 and SW8 and closing switches SW9 and SW10. In this configuration, the portion of the primary coil 336 is disconnected and high-speed communication takes place over the communication coil 338. The communication circuitry 320, 332, 334 prepares the data for high-speed communication using a high speed communication protocol, such as the near field communication protocol or the TransferJet protocol. MEMS switches may be used to obtain desired isolation and simplify switching while minimizing losses, costs, and size associated with conventional relays. Of course, in other embodiments, any suitable switching element may be utilized. An example of additional uses of these switches are to protect input circuitry when other power may be present from other wireless power systems.

The controller may perform appropriate processing of the data. For example, if the data relates to the operation of the power supply, the controller may adjust the operating frequency or rail voltage in response. Or, if the data is unrelated to operation of the power supply, the controller may pass the data through to an optional third party device (not shown) that the wireless power supply is in communication with, such as a computer. The computer may use the data to synchronize with the remote device, or perform some other function with the remote device data. In one embodiment, the high-speed communication is used to communicate from remote device to remote device. For example, data transfer may include pictures, music, or contact lists in order to remove any previously wired communications to that device.

The remote device 304 may or may not include multiple wireless power inputs as described in connection with the first aspect of the invention. In the current embodiment, the remote device 304 includes a single wireless power input, in the form of a hybrid secondary.

The remote device 304 includes circuitry for powering a remote device load 316 including a hybrid secondary 306, a rectifier 312, an optional DC/DC converter 313, a controller 314 that all act in a similar manner to the corresponding components in the wireless power supply 102. In addition, the remote device 304 includes circuitry related to high-speed communications including the communication coil 348, conditioning circuitry 344, and some transistor-transistor logic 342. The controller 314 may also include some additional programming associated with the high-speed communications.

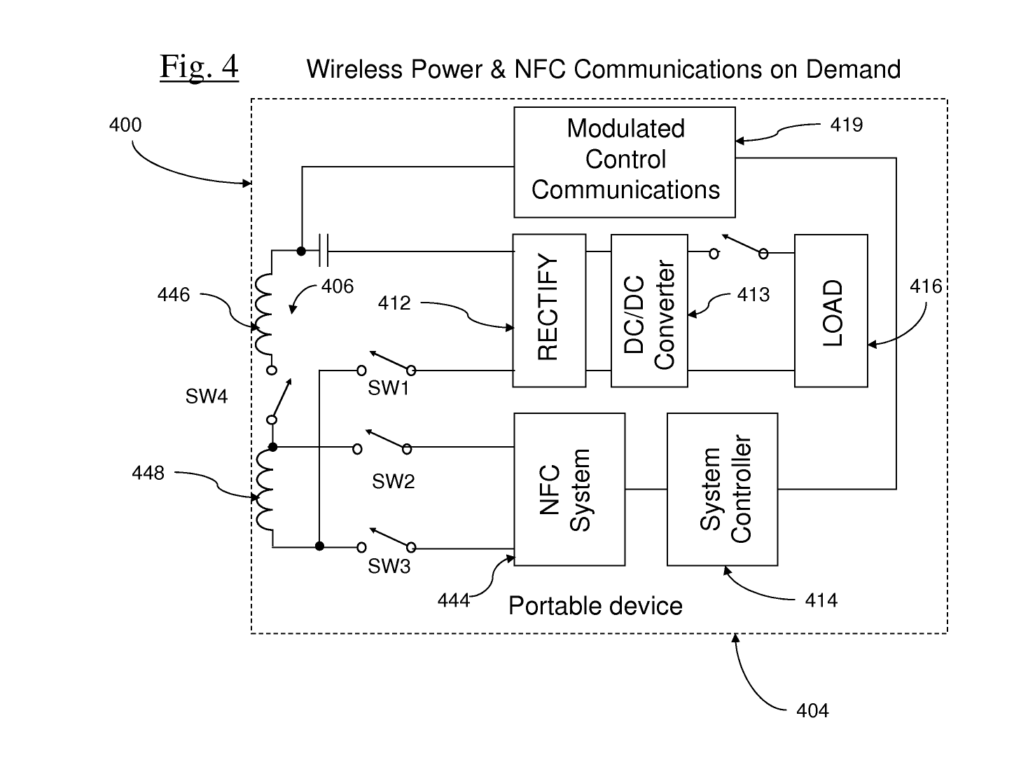

Operation of the hybrid secondary 306 is similar to that of the hybrid primary 330 described above. The hybrid secondary 306 includes a portion of a secondary coil 346 and a communication coil 348 selectably connected by way of a switch SW3. The hybrid secondary 306 may be configured in a first configuration for receiving wireless power by closing switches SW1, SW2, and SW3 and opening switches SW4 and SW5. This creates an open circuit to the communication circuitry 342, 344 and allows the remote device 304 to receive wireless power. During this configuration, the communication coil 348 is electrically connected in series with the portion of the secondary coil 346 and together they act as an appropriate secondary coil for a suitable wireless power source. The hybrid secondary 306 may be configured in a second configuration for communicating high speed data by opening switches SW1, SW2, and SW3 and closing switches SW4 and SW5. In this configuration, the portion of the secondary coil 346 is disconnected and high-speed communication can take place over the communication coil 348. The communication circuitry 314, 342, 344 may transfer the data using a high-speed communication protocol, such as the near field communication protocol or the TransferJet protocol. A block diagram of one embodiment utilizing the NFC protocol is illustrated in FIG. 4. In the current embodiment, radio frequency microelectromechanical system (MEMS) switches are used to obtain desired isolation and simplify switching while minimizing losses, costs, and size associated with conventional relays. MEMS switches may be manufactured in small low cost arrays that provide functionality like relays. Of course, in other embodiments, any suitable switching element such as a relay may be utilized.

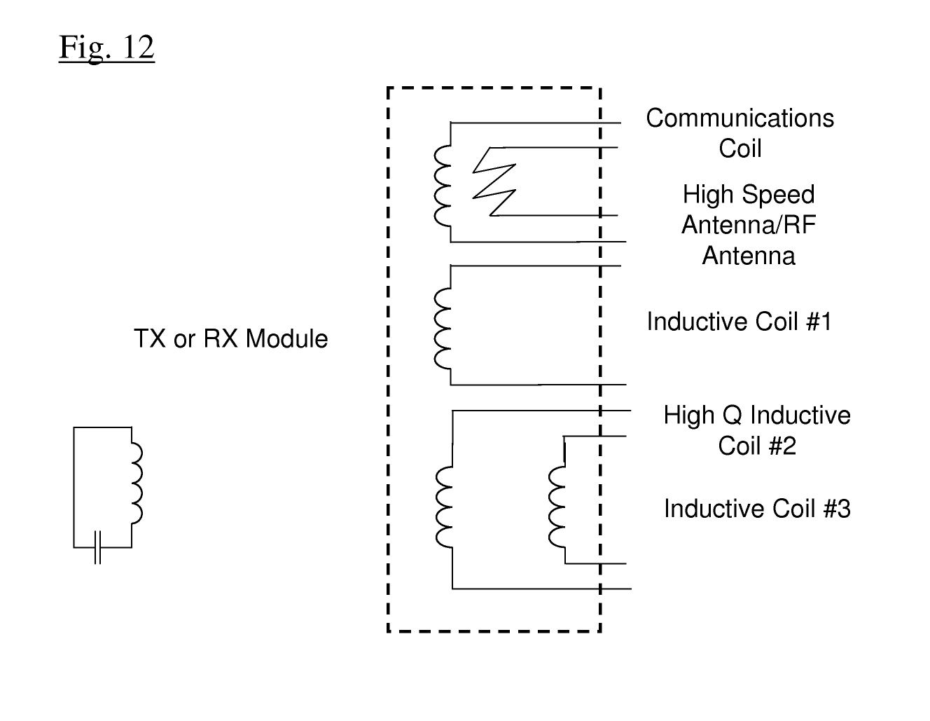

The hybrid secondary element occupies less space than two corresponding separate secondary elements. For example, where the remote device includes a housing having an aperture capable of passing wireless communication and wireless power, the hybrid secondary element may occupy a relatively smaller amount of physical space within the aperture of the remote device than two separate secondary elements would occupy in the aperture. Multiple coils and antennas can be configured in a module as shown in FIG. 12. The module may be designed for a wireless power system primary or for a remote device secondary. Furthermore the complete wireless power electronics and associated parts can be designed into one package with simple input and output connections.

### IV. Time Slicing Communication

A remote device in accordance with an embodiment of one aspect of the present invention is shown in FIG. 4, and generally designated 400. The remote device 404 includes circuitry for powering a remote device load 416 including a hybrid secondary 406, a rectifier 412, an optional DC/DC converter 413, a controller 414 that all act in a similar manner to the corresponding components in the wireless power supply 302, described above. In addition, the remote device 404 includes two separate communication systems, a high speed communication system for transferring power while no wireless power transfer is occurring and a lower speed communication system able to transfer power during wireless power transfer. In the current embodiment, one communication system is a modulated control communication system 419 that is capable of communicating during wireless power transfer, for example by using backscatter modulation. The other communication system is the near field communication system 444 that is capable of communicating at a higher speed than the modulated control communication system 419 while no power transfer is taking place. In general, the modulated control communication system 419 communicates at a lower data rate than the NFC system 444. The modulated control communication system 419, may be replaced with any suitable communication system that may transmit data while power transfer is active. The NFC system 444 may be replaced with any suitable communication system that may transmit data at a relatively high rate while power transfer is not active.

In the current embodiment, the remote device 404 includes a hybrid secondary 406 that may be selectively configured to either wirelessly receive power or to wirelessly communicate high speed data. However, alternative embodiments may not use a hybrid secondary. For example, the hybrid coil may be replaced by a separate secondary and communication element.

In one embodiment, the remote device 404 may utilize either communication system 419, 444 to communicate while wireless power transfer is not taking place. For example, the modulated control communication system 419 may communicate or the near field communication system 444 may communicate when the wireless power transfer has been terminated, removed or completed.

The various criteria for determining when and which communication system to utilize may vary depending on a wide variety of criteria. For example, there may be a threshold for the amount of data. Below the threshold, low speed communications are used and above the threshold, high-speed communications are used. There may be some power costs associated with reconfiguring or enabling the high-speed communication system, so it may make sense to restrict the amount of data that is transmitted using the high-speed transmission system. Further, the number of time slices available where wireless power is not being transferred may be limited, especially where the wireless power supply is employing an intermittent trickle charge to the device.

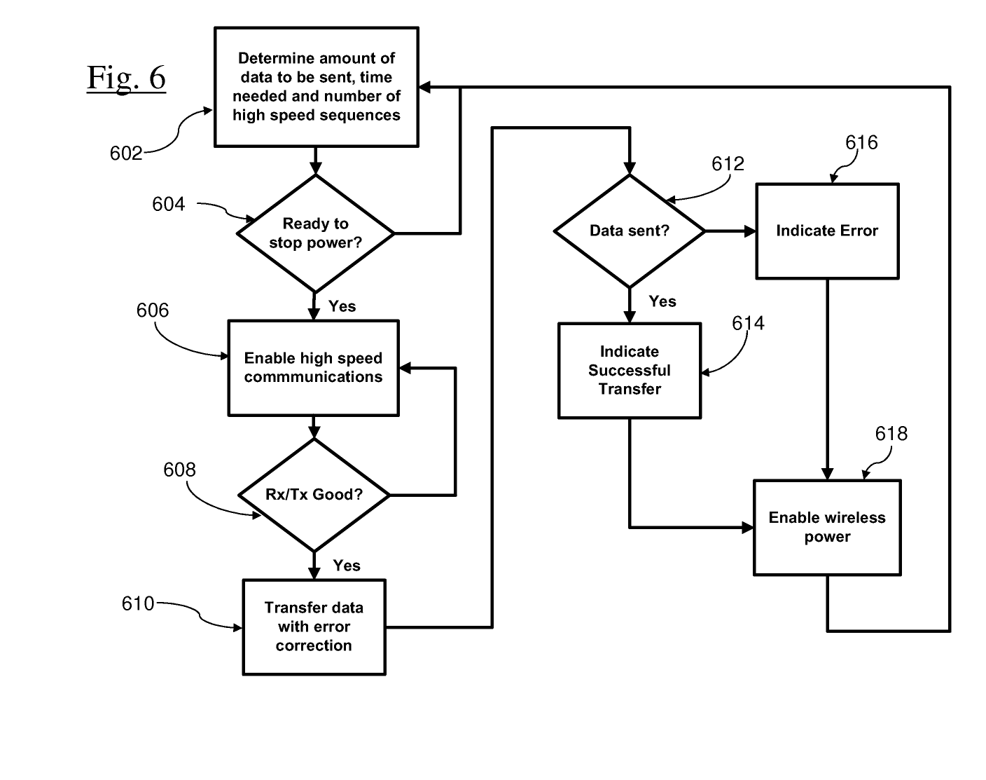

The flowchart of FIG. 6 shows one embodiment of a method of communicating and transferring wireless power. The method begins with determining the amount of data to be sent, the estimated time to send it, and the estimated number of high speed sequences that will be necessary to send the data 602. A determination is made by the wireless power supply or remote device about whether it is ready to stop power 604. If power transfer continues, then communication continues to prepare and queue data to be sent 602. If power transfer is ready to stop, then power transfer may be stopped and high speed communications may be initiated 606. The system determines whether a wireless connection can be established 608 and proceeds to transfer data if it can be 610. If a high-speed wireless communication connection cannot be established then additional attempts may be made before timing out. The data may be sent with or without error correction. Once some or all of the data is sent 612, the system indicates whether the transfer was successful 614 or whether there was an error 616. Once the communication is complete or a sequence of communication is complete, wireless power may be enabled again 618 and the communication may wait for the next opportunity for a high-speed communication opportunity 602.

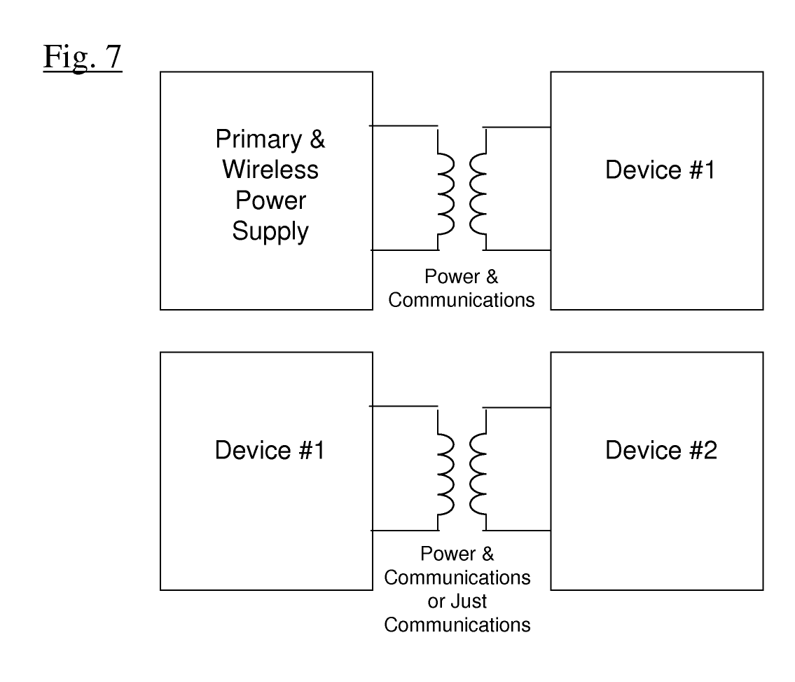

The wireless power input in a remote device may be utilized for device to device communications. One example of this is shown in FIG. 7 where one remote device can communicate with a wireless power supply or another remote device when no power transfer is happening. In the current embodiment, a ping method may be initiated by the remote device to establish a communications link with the wireless power supply or other remote device. In one embodiment, the ping is initiated by a user so that the remote device looks for a compatible device for a predetermined period by waiting for a return ping.

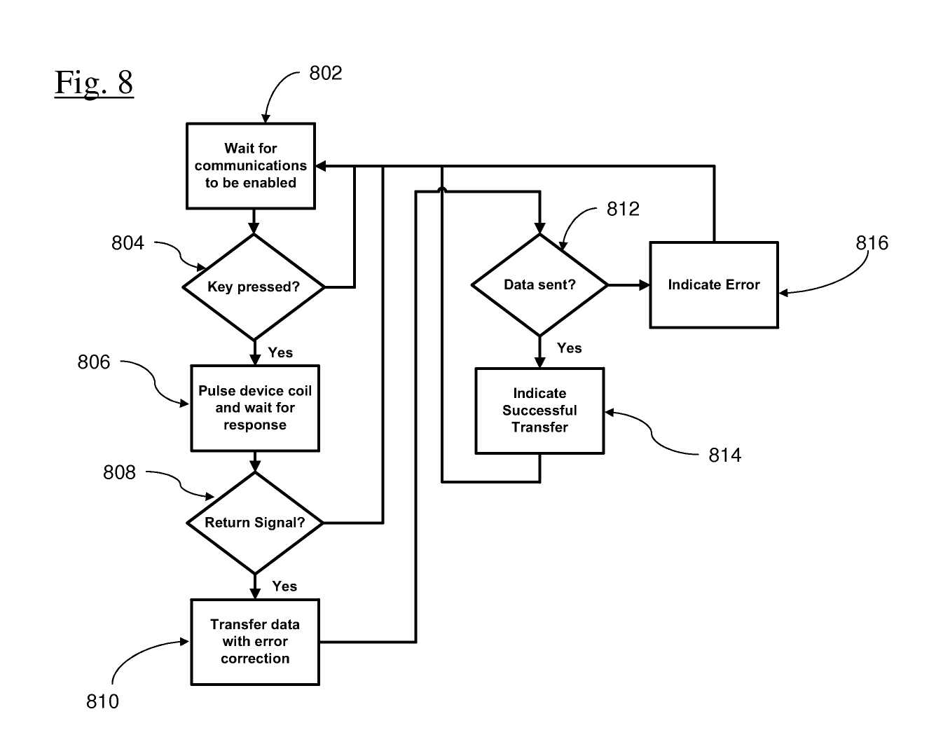

The sequence identified in FIG. 8 may be used to initiate communications and then when the devices are placed in proximity to each other the data can be transferred. In this embodiment, the system may utilize low speed communication during power transfer and switch to a high speed communication system when wireless power transfer is not taking place.

One method for establishing communication is described in FIG. 8. The ping methodology described in FIG. 8 is merely one example of a way of establishing communication between devices. In the current embodiment, both devices wait for communication to be established 802. A user presses a key on the device to activate the ping and attempt to establish communication 804. If no key is pressed, the device will continue to wait for communication to be established 802. If the key is pressed than the device pulses its secondary coil or communication coil and waits for a response 806. If no response is received, then the device will return to waiting for communication to be enabled 802. If a response is received, data transfer will begin 810. Both devices may be running the same algorithm, so in order to begin communication, a key is pressed on each device to establish the presence and status of both devices. Alternatively, the devices may be programmed to respond to the ping, requiring only one of the devices to have a key pressed to begin initiation of the communication transfer. Of course, the key press could be a physical button on the device, or a virtual button on the user interface of the device. In the current embodiment the communication transfer includes error correction 810. In alternative embodiments, error correction may be unnecessary. Once some or all of the data is sent 812, the device may indicate whether there was an error 816 or whether the data transfer was successful 814.

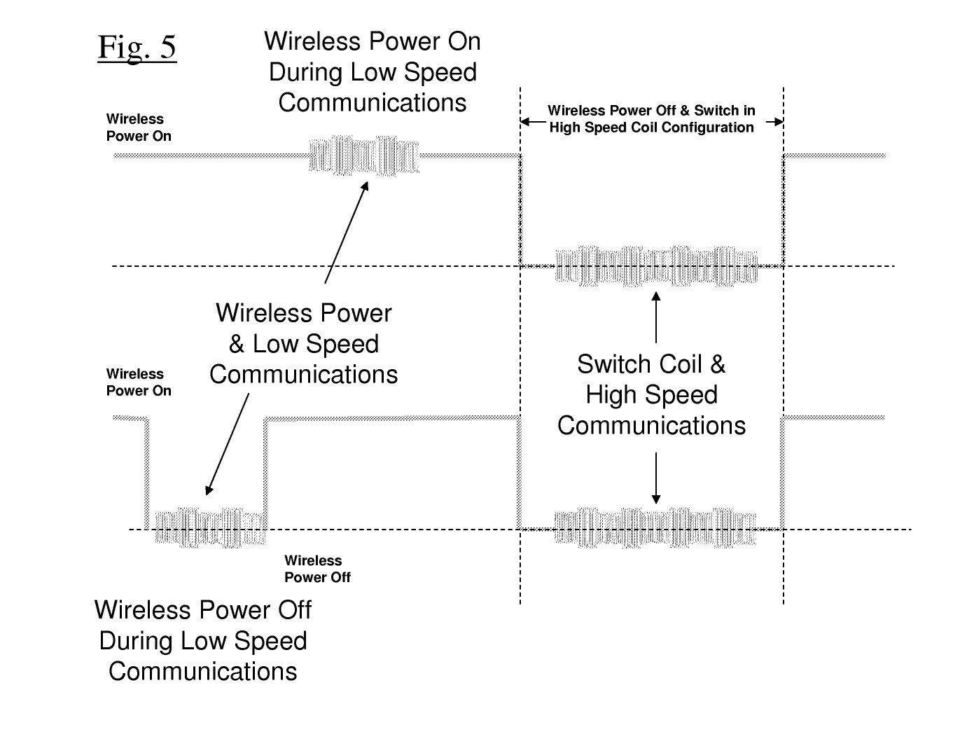

In some embodiments, such as the method illustrated in FIG. 8, the device may be programmed to initiate communication automatically in response to termination of wireless power transfer. In some embodiments, a key press to initiate the communication may be unnecessary. Instead, any data waiting to be sent may instead be sent as soon as the high-speed communication channel is available. Further, the remote device may utilize two separate communication channels by time slicing communication. That is, during wireless power transfer, a first communication system may be utilized to transfer data and when wireless power transfer stops, a second communication system may be utilized to transfer data. The rate at which communication may be enabled may be faster while power is not being transferred. The current embodiment allows communications to be seamlessly time sliced in such a way that the end user is unaware that multiple communication systems are being used to transfer a set of data. A representative graph of when each communication system may be utilized is shown in FIG. 5. The top graph shows that wireless power is on and that intermittent low speed communications may take place during the power transfer. Once the wireless power is turned off, high-speed communications may begin. In the current embodiment, this may include reconfiguring the hybrid secondary for high-speed communication. The second graph illustrates that in some circumstances low speed communications may be utilized even while the wireless power system is not transferring power.

### V. Far Field Ultra Low Power

Known far field power supplies provide wireless power without using feedback. Accordingly, known far field power supplies and remote devices enabled to receive such wireless power do not utilize a communication channel. Although feedback may be unnecessary for monitoring or adjusting the far field wireless power transmission, there are a number of other benefits that may be provided by having an appropriate communication channel between a remote device and a far field wireless power supply.

One benefit of a communication channel between a remote device and a far fields power supply is that the far field power supply may utilize an ultra low power mode. Wireless communications may be utilized to enable and control the far field wireless power source. The far field wireless power source may be a multi state low power wireless system similar to the systems disclosed in U.S. Ser. No. 12/572,296, entitled “Power System” (filed Oct. 2, 2009), which is hereby incorporated by reference for wireless power. In the current embodiment, a wireless signal signals to the wireless power supply to exit low power mode and to begin transmission of wireless power.

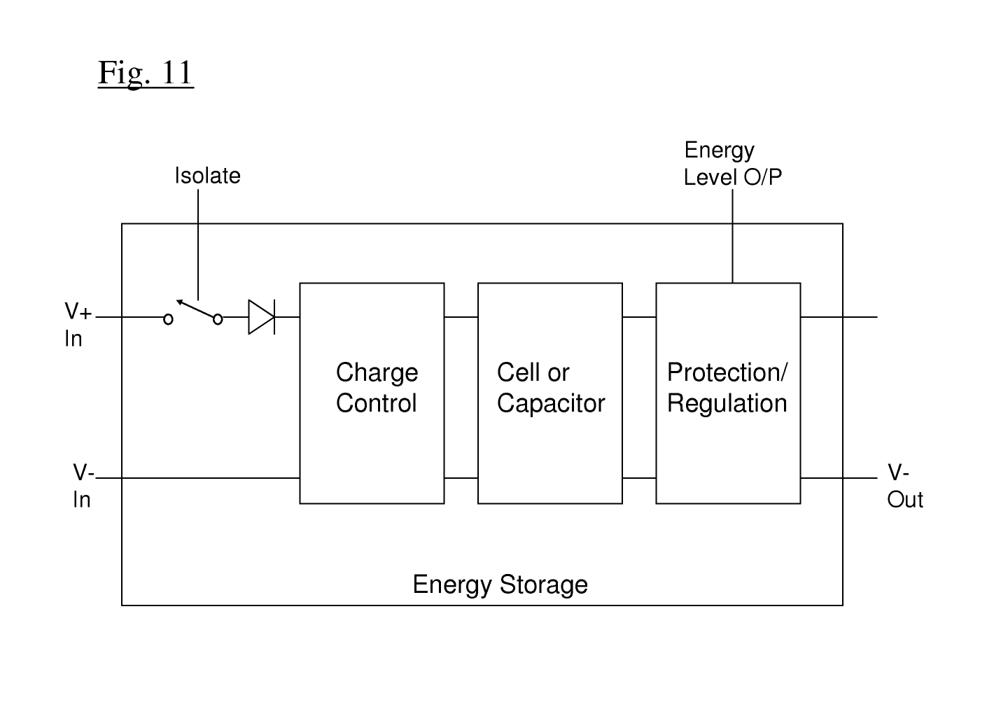

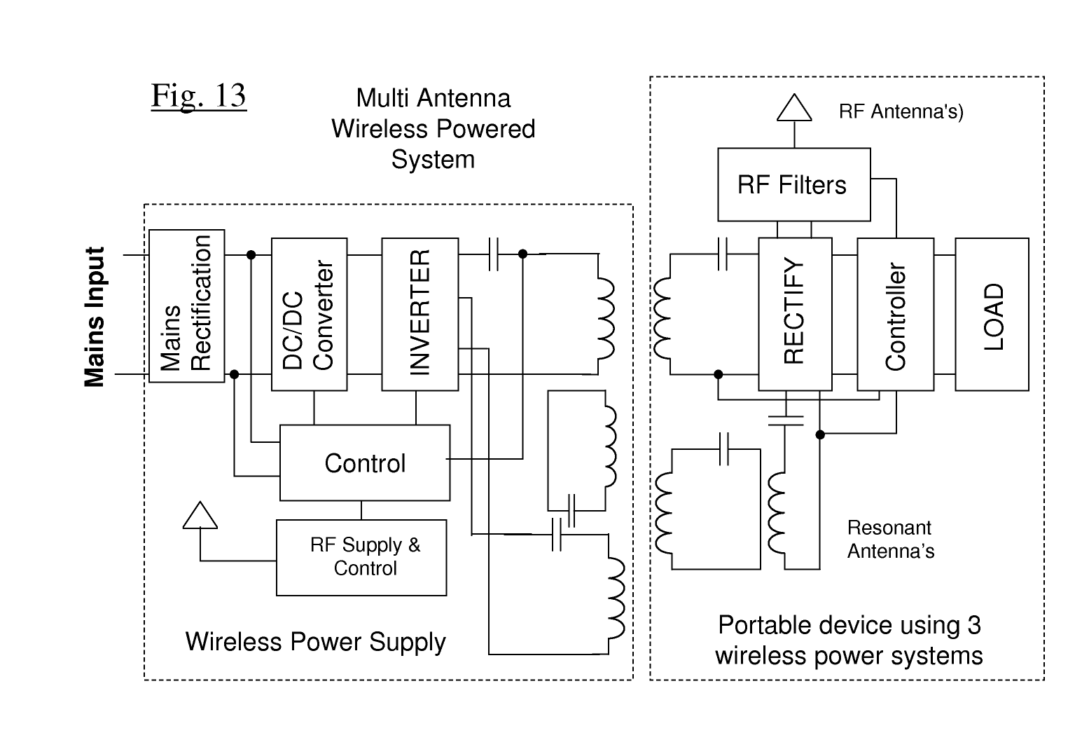

The wireless power source includes a power supply 902 that conditions the mains input AC power into DC power. The wireless power source also includes an inverter 904 that creates an AC signal for the wireless power supply 906. The wireless power source also includes a controller 908 and an RF antenna 910 for receiving wireless signals from a remote device. The controller is programmed to selectably operate the RF far field wireless power supply between an ultra low power mode and a power transmission mode. This is also shows in FIG. 13 where the larger coil resonant inductive system may also be controlled by RF or load modulated communications. During the ultra low power mode, switch SW1 is open and various circuitry within the wireless power source may be powered down. The controller 908 may include an energy storage element that allows minimal operation of the RF antenna and the ability to exit the low power state in response to receiving a signal that a remote device is nearby and desires wireless power. FIG. 11 shows an energy storage element that may be included within the RF Transceivers power source. Although the low power mode described above contemplates shutting off wireless power supply entirely during the lower mode, it should be understood that switch SW1 may be removed and the wireless power transmission may be reduced, used for communications only or turned off without creating an open circuit to the mains power supply.

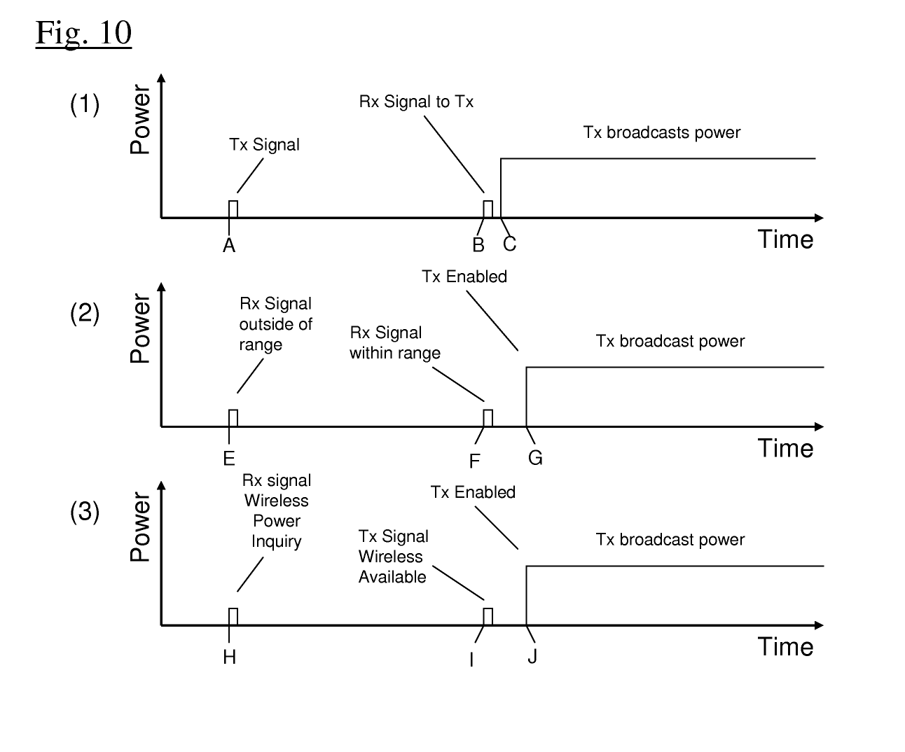

The representative graphs shown in FIG. 10 provide some examples of how the low power mode works within a far field power supply. The first graph shows the low power mode where the wireless power supply transmits a low power intermittent RF signal (A). The device upon receiving the signal from the wireless power supply responds with a corresponding RF signal (B) to which the transmitter receives and in turn exits low power mode and enables the transmission of wireless power (C). The second graph shows a watch dog RF signal enabled in the device when it is ready for wireless power. The signal (E) can be keyboard or switch enabled, time enabled or event enabled. When the receiver comes within range of a far field wireless power supply, the wireless power supply will receive the signal (F) and in turn exit low power mode and enable the transmission of wireless power (G).

### VI. Wireless Power Hot Spots

In one aspect of the invention, a remote device has the capability of communicating with multiple different wireless power sources to indicate a wireless power hot spot is nearby. The remote device transmits a wireless signal and if a wireless power source is present, but not within range for the remote device to receive wireless power then the wireless power source may respond by transmitting a wireless signal indicating that a wireless hotspot is nearby.

The representative graph of FIG. 10 illustrates one embodiment of how wireless power hot spot indication could work. In the illustrated embodiment, a remote device transmits a signal (H). If a wireless power supply is within range, it may respond with a wireless signal (I) indicating that wireless power is available. The wireless power source may include a variety of additional information as well. For example, the wireless power source may include an indication about whether or not the remote device is within range to receive wireless power. Upon receiving the RF signal the power source can indicate it's within range with a flashing light, a return signal to the remote device or other visual or audible signals in the device. In addition, the wireless signal may include a variety of different information, such as power class information, location information, cost information, capacity information, and availability information.

Power class information may indicate whether the wireless power source is a be to power low, medium or high classifications of devices and any combinations. For example, some wireless power supplies may be capable of charging low, medium, and high power class devices, while other wireless power supplies may only be capable of charging low and medium or just low class devices. The power class information may also have specific power data available, such as specific voltage and current levels. There is a description of some power class information in U.S. Ser. No. 12/349,355 to Baarman et al, entitled “METERED DELIVERY OF WIRELESS POWER FOR WIRELESS POWER METERING AND BILLING” (filed Jan. 6, 2009), which is herein incorporated by reference.

Wireless charging capacity may allow a user to see how much capacity is available within a region or charging area. The information may be conveyed in a number of different forms, including, but not limited to an indication of the amount of wattage available or the number of wireless charging hot spots available. Capacity may be indicated in the terms of available power or priority charging which can use charge status and load as indicated in U.S. Patent Application Ser. No. 61/142,663 to Baarman entitled WIRELESS CHARGING SYSTEM WITH DEVICE POWER COMPLIANCE, filed on Jan. 6, 2009 to set the power priorities as shown in other inductive systems.

### VII. Multiple Wireless Power Supply

In one aspect of the invention, a wireless power supply has the capability of supplying multiple types of wireless power. In the current embodiment, the wireless power supply includes a wireless power transmitter including three different wireless power transmitter elements. IN particular, the embodiment illustrated in FIG. 13 includes a wireless transmitter for transmitting RF energy 1302, a wireless transmitter for transmitting near field far edge power with a larger loop inductive coil 1304 and smaller loop inductive coupling 1306, and a transmitter for resonant inductive coupling 1308. The wireless power supply system shown in FIG. 13 also includes a remote device with multiple wireless power inputs that align with multiple wireless power transmitters of the multiple wireless power supply.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A remote device comprising:
a first wireless power input optimized for wireless power from a first wireless power source;
a second wireless power input optimized for wireless power from a second wireless power source, wherein said first wireless power source and said second wireless power source are different types of wireless power sources;
a load; and
a controller programmed to control which of the first wireless power input and the second wireless power input provide power to the load of the remote device.

2. The remote device of claim 1, wherein the first wireless power input is optimized for wireless power from at least one of the following list of wireless power sources: electromagnetic near field, electromagnetic far field, electromagnetic near field far edge, RF broadcast, and ambient RF energy, and the second wireless power input is optimized for wireless power from one of the remaining wireless power sources in the list of wireless power sources.

3. The remote device of claim 1, wherein the controller is programmed to control which of the first wireless power input and the second wireless power input provides power to the load of the remote device at least in part based on a characteristic of power present on the first wireless power input and a characteristic of power present on the second wireless power input.

4. The remote device of claim 3, wherein the characteristic of power present on the first wireless power input includes at least one of efficiency and charge capability.

5. The remote device of claim 1, wherein the controller is programmed to control which of the first wireless power input and the second wireless power input provides power to the load of the remote device based at least in part on a characteristic of the load.

6. The remote device of claim 1 including a power management system, wherein the controller is programmed to control which of the first wireless power input and the second wireless power input provides power to the load of the remote device based at least in part on communication with the power management system.

7. The remote device of claim 1, wherein the controller is programmed to provide power from both the first wireless power input and the second wireless power input simultaneously to the load.

8. The remote device of claim 1, wherein the controller is programmed to control which of the first wireless power input and the second wireless power input provides power to the load of the remote device based at least in part the charge capability of the wireless power input.

9. The remote device of claim 1 including a rectifier for rectifying the power from at least one of the first wireless power input and the second wireless power input.

10. A remote device comprising:
a hybrid secondary selectively configurable between a first configuration optimized for wireless power from a first wireless power source and a second configuration optimized for wireless power from a second wireless power source;
a load; and
a controller programmed to selectively configure the hybrid secondary between the first configuration and the second configuration.

11. The remote device of claim 10 including an aperture for wireless power, wherein the hybrid secondary occupies a relatively smaller amount of physical space within the aperture than two separate secondary elements optimized respectively for wireless power from the first wireless power source and the second wireless power source occupy in the aperture.

12. A far field wireless power system comprising:
a remote device including a far field antenna for harvesting RF energy;
a far field wireless power source having a low power mode and an RF energy transmission mode, the far field wireless power source utilizes less power during low power mode than during power transmission mode; and
wherein the remote device and the far field wireless power source communicate using an intermittent signal to enable the far field wireless power source to change from low power mode to RF energy transmission mode.

13. The far field wireless power system of claim 12 wherein the remote device transmits the intermittent signal, the far field wireless power source receives the intermittent low power signal and in response enables transmission of far field wireless power.

14. The far field wireless power system of claim 12 wherein the far field wireless power source transmits the intermittent signal, the remote device receives the intermittent signal and communicates with the far field wireless power source to enable transmission of far field wireless power.

15. The far field wireless power system of claim 14 wherein the remote device includes a battery and the far field antenna is capable of harvesting sufficient energy to transmit the intermittent signal when there is insufficient power in the battery to transmit the intermittent signal.

16. The far field wireless power system of claim 11 wherein the far field wireless power source in the low power mode operates using an energy storage element that enables operation of an RF antenna and the ability to exit the low power mode in response to receiving a signal that the remote device is nearby and desires wireless power.

17. The far field wireless power system of claim 11 wherein the far field wireless power source shuts off or reduces wireless power supply during low power mode.

18. A wireless power supply comprising:
a plurality of wireless power transmitters, each of the wireless power transmitters capable of supplying a different type of wireless power.

19. The wireless power supply of claim 17 wherein the plurality of wireless power transmitters include at least two of a wireless transmitter for transmitting RF energy, a wireless transmitter for transmitting near field far edge power, and a wireless transmitter for resonant inductive coupling.

20. The wireless power supply of claim 17 including a mains rectification circuit, a DC/DC converter, a controller, and an inverter, wherein the controller is programmed to control the plurality of wireless power transmitters.

21. The wireless power supply of claim 17 for use with a remote device including a plurality of wireless power inputs.
